(19) United States
(12) Patent Application Publication
(10) Pub. No.: US 2008/0085346 A1
(43) Pub. Date: Apr. 10, 2008

(54) Treatment System and Method for Preserving Fresh Produce

(75) Inventors: Howard Kravitz, Wayne, PA (US); Shane Hartman, Bloomsburg, PA (US)

Correspondence Address: MCNEES WALLACE & NURICK LLC, 100 PINE STREET, P.O. BOX 1166, HARRISBURG, PA, 17108-1166, US

(73) Assignee: BROAD RUN HOLDINGS, INC., Wilmington, DE (US)

(21) Appl. No.: 11/869,380

(22) Filed: Oct. 9, 2007

Related U.S. Application Data
(60) Provisional application No. 60/828,664, filed on Oct. 9, 2006.

(51) Int. Cl. A23L 3/34

(52) U.S. Cl. 426/268; 426/303; 426/532

(57) ABSTRACT

A treatment system and method for preserving fresh produce is disclosed. The method includes providing fresh produce to be preserved, washing the fresh produce in an aqueous solution of hydrogen peroxide having a pH greater than about 9.0, and washing the fresh produce in a mixture of a anti-microbial agent and an acid activator. The system includes tanks containing the wash solutions and conveyor system to transfer fresh produce to and from the tanks.

### CROSS REFERENCE TO RELATED APPLICATIONS

This application claims the benefit of U.S. Provisional Application 60/828,664, filed Oct. 9, 2006 which is hereby incorporated by reference in its entirety.

### FIELD OF THE INVENTION

The present invention is directed to food preservation and more particularly to a treatment system and method for preserving fresh produce.

### BACKGROUND OF THE INVENTION

Historically, mushrooms and other fresh produce were, and in many cases continue to be, sold without washing. Prior to consumption, the consumer will usually wash the mushrooms and other produce to remove dirt, compost, peat, and other organic and inorganic residue. Food service purchasers also have to wash produce, but in some cases, especially with mushrooms, may elect to leave some residual growing medium on the mushrooms where the mushrooms will be cooked during food service preparation.

Both groups would prefer to purchase the mushrooms free of the compost/peat. In either case, washing the produce is a time-consuming task that consumers and food service purchasers would rather not undertake. Therefore, supplying mushrooms and other produce that is pre-washed is highly desirable. However, ordinary washing of the mushrooms in water pre-maturely breaks the sub-cellular structures in the cap cuticle or mushroom surface allowing enzymes (tyrosinase or polyphenol oxidase) held therein to mix with the mushroom substrate. Additionally, bacteria causes a break down the sub-cellular structures. With the ensuing release of enzymes, discoloration occurs.

Some of the first efforts to provide pre-washed produce that would overcome these problems produce included the use of sulfites. However, allergy sensitivities of consumers eventually led to an FDA ban of sulfites in the mid-1980s for this purpose.

Following the banning of sulfites, numerous attempts have been made to develop washing systems. These systems have been focused primarily on reducing bacteria and retarding the on-set of discoloration.

However, treatment methods developed to-date to address these concerns have been less than optimal in both performance and economics. These treatments were generally accomplished either by the use of hydrogen peroxide or by high pH washes. Sodium hypochlorite washes have also been used, but have been unsatisfactory at extending shelf-life beyond a few days. Treatments including erythorbic acid, sodium erythorbate and calcium disodium EDTA have also been used to reduce enzymatic discoloration by interrupting the reaction or sequestering trace compositions of copper which catalyze the reaction. In any event, even under good storage temperature conditions, current treatment techniques typically provides shelf-life extension of only 5 to 10 days before the onset of bacterial breakdown and/or discoloration, such as enzymatic browning.

The problems caused by bacterial breakdown and discoloration discussed above are not unique to mushrooms. Other fresh cut and whole produce face similar problems that may reduce shelf life because the food either becomes unsafe to eat or visually and/or texturally undesirable to the consumer.

Therefore, what is needed is a treatment for fresh produce that delays the onset of bacterial break down with related softening and discoloration in fresh produce.

### SUMMARY OF THE INVENTION

The present invention involves a two-stage washing system that maintains low levels of bacteria in fresh produce for extended periods of time. An anti-microbial component of the invention controls bacteria and discoloration, while an acid activates and enhances the efficacy of the anti-microbial component. In a preferred embodiment, the acid activator is also an enzymatic inhibitor that also controls discoloration.

According to an exemplary embodiment of the invention, a treatment method for preserving fresh produce is disclosed. The method comprises providing a fresh produce to be preserved, washing the fresh produce in an aqueous solution of hydrogen peroxide having a pH greater than about 9.0 and thereafter washing the fresh produce in an aqueous solution of an anti-microbial agent and an acid activator. In one embodiment, the fresh produce is mushrooms.

According to another exemplary embodiment of the invention, a treatment system for preserving fresh produce is disclosed. The system comprises a first tank containing an aqueous solution of hydrogen peroxide having a pH greater than about 9.0; and a second tank containing an aqueous solution of an anti-microbial agent and an acid activator.

One advantage of the invention is that fresh produce treated in accordance with exemplary embodiments of the invention have improved shelf life by significantly reducing bacteria levels. As a result, bacterial growth starts from a lower platform resulting in a longer shelf life and a delay in the onset of discoloration and/or softening.

Still another advantage of the invention is that in some embodiments the acid activator is also an enzymatic inhibitor, simultaneously activating and enhancing performance of the anti-microbial component while acting as an anti-oxidant that further delays the onset of discoloration.

Another advantage of the invention is that components in the treatment process, including hydrogen peroxide and chlorine dioxide, dissipate over time, reducing the amount of residual chemicals on the produce which are undesirable to consumers.

Yet another advantage of the invention is that reducing bacteria levels on the outside of produce reduces the amount of bacteria transferred onto slicing and other preparation machines, in turn reducing the amount of bacteria the slicing blades transfer to previously unexposed surfaces of the sliced produce.

Other features and advantages of the present invention will be apparent from the following more detailed description of exemplary embodiments, taken in conjunction with the accompanying drawings which illustrate, by way of example, the principles of the invention.

### BRIEF DESCRIPTION OF THE DRAWINGS

FIG. 1 illustrates a method in accordance with an embodiment of the invention.

FIG. 2 is a schematic of a treatment system in accordance with an exemplary embodiment of the invention.

FIG. 3 illustrates a method in accordance with an alternative embodiment of the invention.

### DETAILED DESCRIPTION OF EXEMPLARY EMBODIMENTS

Most fresh produce is grown in or on the ground, or otherwise comes into contact with the ground or soil at some point before, during or after the harvest. That is, even if some produce is not in contact with the soil, during processing it comes into contact with other produce which has been in contact with the soil, potentially introducing contaminants. Washing this produce in a way that provides for consumer protection and shelf life extension is important.

Exemplary embodiments of the invention are directed to a multi-stage treatment system and method to preserve fresh produce. As used herein, the term “fresh produce” includes both cut and whole fresh fungi, fruits and vegetables. Mushrooms and skinned fruits and vegetables are particular fresh produce of interest. “Skinned” fruits and vegetables include any fruit or vegetable which has a discernable skin or peel distinguishable from its flesh and include citrus, pomme and stone fruits, tubers, cucurbits, artichokes, alliums and root vegetables, by way of example only. However, exemplary embodiments of the invention encompass all fresh produce such as greens, celery, and berries as well, by way of example only.

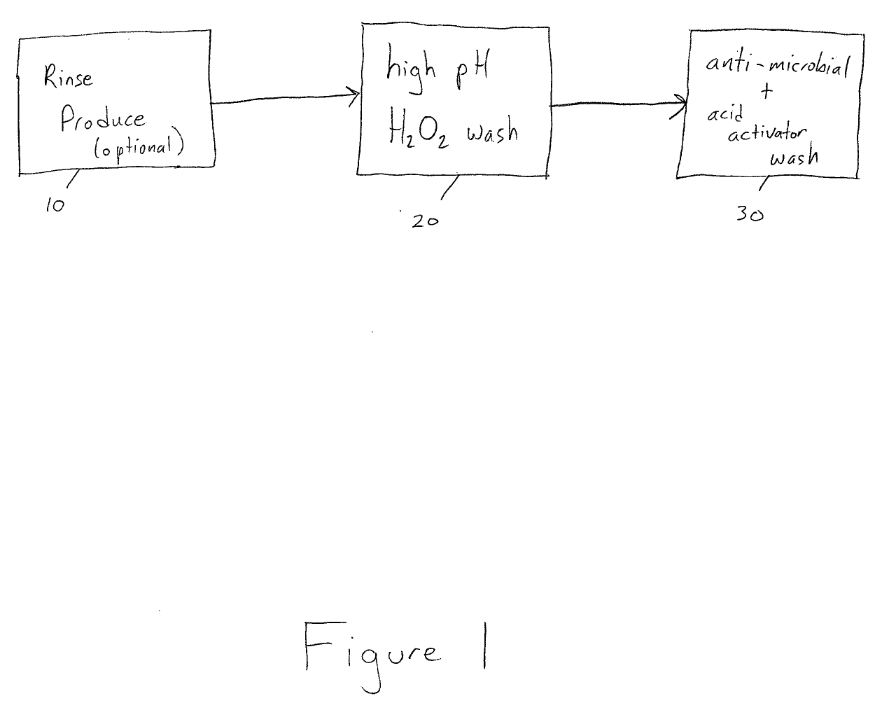

According to one embodiment, illustrated in FIG. 1, the method includes an optional preliminary stage treatment (step 10) in which mushrooms or other fresh produce is rinsed in a tank of potable water. The optional preliminary rinsing may be used to clean the produce and/or rid it of any incidental foreign matter, such as soil, compost, pesticides, insects and the like.

It will be appreciated that the tanks referred to herein may be any size, and generally will depend upon the volume of produce that is to be treated. The method, including the optional preliminary rinsing step, may be conduced as either a batch or continuous process.

After the optional rinsing step, the produce is conveyed, for example using a mesh conveyor, from the preliminary tank to a first stage treatment tank, which may be of the same or different size than the preliminary stage tank, for washing in a high pH hydrogen peroxide solution (step 20). The first-stage treatment tank contains a combination of alkaline material and hydrogen peroxide in water to create an alkaline aqueous solution of hydrogen peroxide.

The concentration of hydrogen peroxide may be in the range of about 600 to about 1000 milligrams hydrogen peroxide per liter of solution, with a preferred range of between about 800 to about 850 milligrams per liter solution. The concentration of alkaline material may be adjusted so that the solution has a pH that is generally in the range of about 9.0 to about 11.0, preferably about 10.0. In one embodiment, the alkaline material is sodium carbonate or sodium bicarbonate. The concentration of sodium carbonate may be in the range of about 1600 to about 2000 milligrams per liter of solution, preferably between about 1750 to about 1850 milligrams per liter solution. In a preferred embodiment, the first stage treatment tank contains an aqueous solution of sodium percarbonate ((Na₂CO₃)·3H₂O₂), which prior to dissolution is a solid compound of sodium carbonate and hydrogen peroxide.

The residence time for the fresh produce in the first stage treatment tank may vary depending on the particular produce being washed, whether or not the produce is cut or whole, and whether or not any agitation is optionally present in the tank. Generally, residence times range from about 20 seconds to about 5 minutes, which provides sufficient time to ensure the produce has been sufficiently treated to achieve the desired results without unduly lengthening the overall processing time. It will be appreciated however, that longer residence times may be used; residence times higher than 10 minutes have been observed without significant deleterious effects on the produce. It will further be appreciated that the overall efficacy is a function of residence time in combination with concentration. Thus, higher concentrations may be used where the residence time is reduced accordingly; conversely, weaker concentrations may still achieve acceptable results where the residence times are increased accordingly.

The hydrogen peroxide is an oxidizing agent to kill mold spores and bacteria, the effects of which, the inventors have discovered, is made more powerful by a food-grade alkaline material such as sodium carbonate. The effect of this combination has been made more successful by using a powdered form of hydrogen peroxide in combination with sodium carbonate for dissolution in water. The powdered form is less dangerous to handle than more common 30% liquid solutions. Furthermore, liquid solutions of hydrogen peroxide degrade relatively quickly, requiring almost continuous adjustments to maintain the proper concentration within the tank. Conversely, the powdered form dissolves slowly over time. Thus, the powdered form of hydrogen peroxide is preferred because it is safer to handle and also provides a more uniform concentration within the treatment tank during processing.

From the first stage treatment tank, the produce is conveyed to a second stage treatment tank for washing with an aqueous solution of an anti-microbial agent and an acid activator (step 30). In a preferred embodiment, the anti-microbial agent is sodium chlorite, which is an inexpensive, readily available source to produce free chlorine dioxide radicals within the solution. However, other sources for the chlorine dioxide radicals may be used, including dissolving gaseous chlorine dioxide into the wash water. The produce may be subjected to spraying or some other form of rinsing with potable water between the various stages of treatment during the treatment process. Rinsing the produce after the first stage treatment to remove excess hydrogen peroxide which can avoid contribution to premature browning by the hydrogen peroxide, which is an oxidizer.

The acid activator may be any suitable organic or inorganic acid that activates and enhances the effectiveness of the anti-microbial component and preferably also acts as an enzymatic inhibitor. Preferably, the acid activator is either ascorbic acid or tartaric acid, which have the duplicative advantages of being both an acid that activates free chlorine dioxide radicals and an enzymatic inhibitor having an independent anti-browning effect on the produce. Tartaric acid has the additional benefit that it is a by-product of the wine industry, and thus turns a potential waste product into a useful item. Lactic acid and fumaric acid may also be used to provide the dual role of acid activator and enzymatic inhibitor, while weak hydrochloric acid (at a concentration of about 1 milliliter per gallon water), is a suitable acid activator.

In one embodiment, the second stage treatment tank contains an aqueous solution having between about 50 to about 150 ppm sodium chlorite, preferably between about 70 to about 90 ppm for mushrooms, while fruits and vegetables, which generally have less sensitive skin, can be exposed to greater concentrations. The acid activator may be present in a concentration in the range of about 200 to about 700 milligrams per liter of solution, preferably between about 250 to about 350 milligrams per liter solution. It will be appreciated, that acid concentrations may be even lower than 200 milligrams per liter of solution when hydrochloric acid is used as the acid activator. Residence times in the second stage treatment tank may be from about 20 seconds to about 5 minutes or more, depending on the particular fresh produce being used, or even longer as discussed above with respect to step 20 depending on concentrations.

In an alternative embodiment, the acid activator may be applied separately from the anti-microbial agent, such as by spraying it on subsequent to the anti-microbial wash. For example, the second stage treatment tank may contain a solution of only sodium chlorite, after which the acid activator is sprayed on as the produce leaves the second-stage treatment tank. In yet another embodiment, some or all of the washing steps may be accomplished by spraying instead of being placed in the wash solutions, although uniform coverage of the produce may be more difficult to obtain.

Other enzymatic inhibitors/acidic activators have been tried, but are not of the same synergistic nature as the combination with ascorbic acid or tartaric acid. These other inhibitors have included erythorbic acid, citric acid, and benzoic acid. Additionally, salts of ascorbic acid have been tried, but are not of the same synergistic nature as the combination with ascorbic acid. These salts include calcium and sodium ascorbate. Also, chelating agents including calcium EDTA were tried without the same success as with no chelating agents. Finally, the addition of calcium as calcium chloride was not effective on mushrooms, but is generally a useful additive to enhance turgidity of cell walls in other sliced produce.

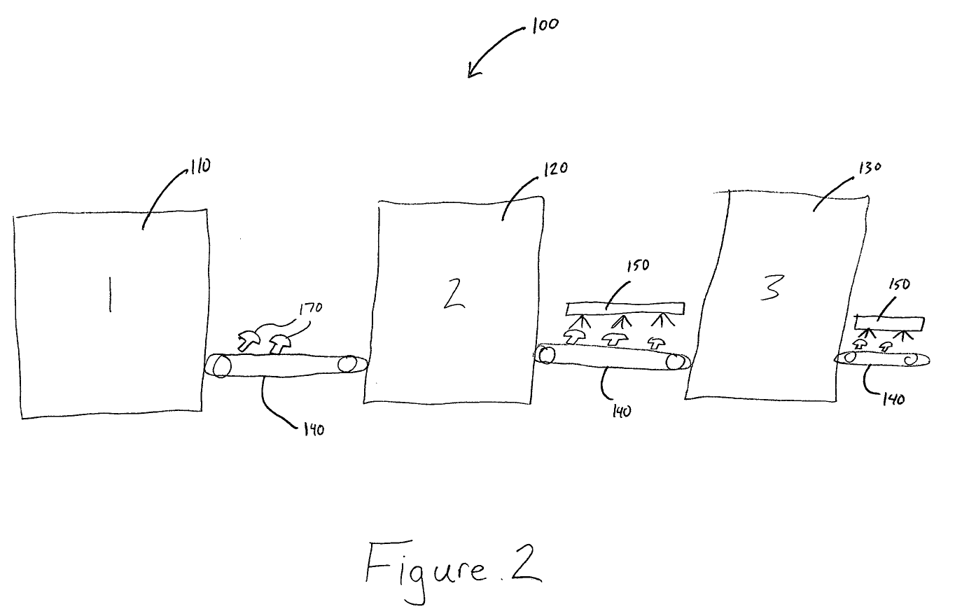

FIG. 2 illustrates in schematic format a system 100 for treating fresh produce in accordance with an exemplary embodiment of the invention. Fresh produce 170 is optionally washed in an optional preliminary treatment tank 110 containing potable water. From the preliminary treatment tank 110, the fresh produce is transferred via a conveyor 140 to a first stage treatment tank 120 containing an aqueous solution of hydrogen peroxide and sodium carbonate or other alkaline material. From the first stage treatment tank 120, the produce 170 is conveyed to a second stage treatment tank 130 containing an anti-microbial agent and an acid activator. Optionally, the fresh produce 170 may be rinsed with potable water, such as by using a spray bar 150, while being conveyed to the second stage treatment tank. After the second stage treatment tank 130, the fresh produce should be rinsed with potable water.

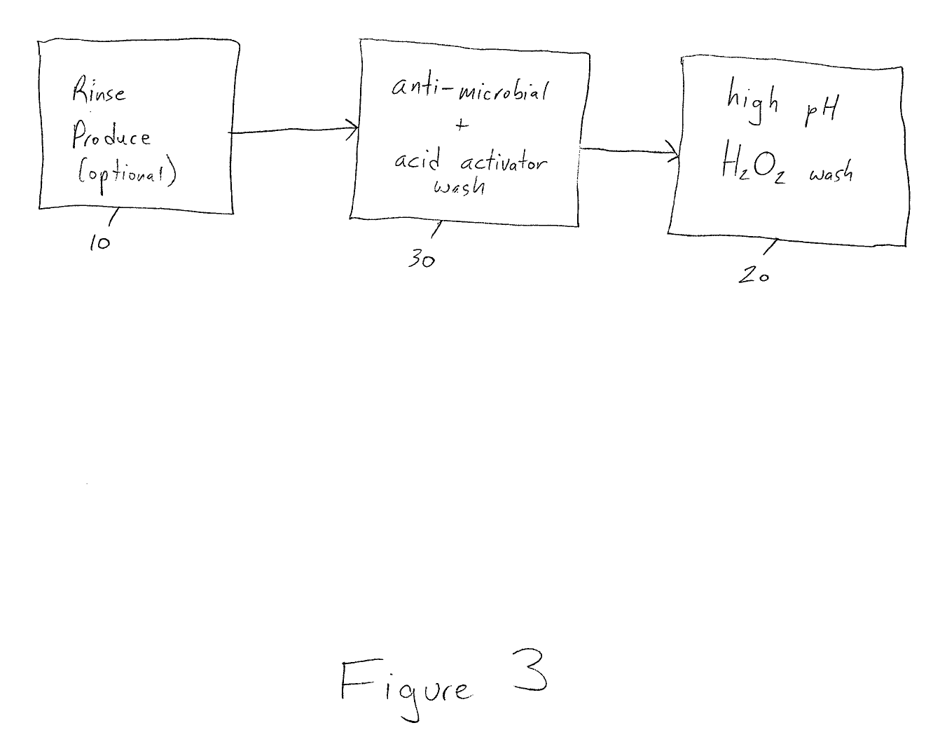

In one embodiment of the invention, following any optional preliminary rinsing, the produce is conveyed to the second stage treatment tank, and then to the first stage treatment tank. That is, in one exemplary embodiment, illustrated in FIG. 3, fresh produce is first treated with the sodium chlorite and acid solution (step 30) before being treated with the hydrogen peroxide and sodium carbonate solution (step 20). This reversed protocol may be particularly advantageous when the fresh produce is a skinned fruit or vegetable, which tend to be less sensitive than mushrooms.

It has been determined that treating skinned fruits and vegetables with the second stage treatment first knocks out any mold spores very quickly, which is particularly advantageous when the fruit or vegetable is damaged or marked, as over time, mold spores not quickly killed can migrate into the fruit or vegetable via the cut. A subsequent dip in the high pH peroxide of the first stage treatment then destroys any remaining bacteria and adds some residual high pH protection to the surface of the produce.

Treatments conducted according to exemplary embodiments of the present invention have been demonstrated to withstand microbial contaminants that are usually found on the exterior of fresh produce after harvest. Compared with the traditional sodium hypochlorite washes used in the industry today, exemplary embodiments of the invention remain effective against microorganisms much longer due to their ability to function even under increased microbial loads on the harvested produce. Furthermore, it has been observed that the two stage treatment process in accordance with exemplary embodiments of the invention provides beneficial results of both increased shelf life and retarded discoloration not observed when either the first or second stage treatment was used alone as a single stage treatment process.

The following examples are presented by way of exemplification and not by way of limitation:

### EXAMPLE 1

Five pounds of Food Grade Sodium Percarbonate (obtained from Kingsfield, Inc.), which is a 70%/30% by weight blend of sodium carbonate and hydrogen peroxide, was added and mixed into 225 gallons of water in a tank (Tank 2). One-half gallon of sodium chlorite (obtained as Adox 750 commercially available from International Dioxcide, Inc.) and one-half pound of food grade ascorbic acid were added to 425 gallons of water in a different tank (Tank 3).

Freshly harvested whole mushrooms were conveyed at a rate of 160 pounds per minute to a first tank (Tank 1) containing 225 gallons of potable water (no chemicals added). Residence time in Tank 1 was 30 seconds. From Tank 1, the mushrooms were conveyed directly into Tank 2, again with a residence time of 30 seconds. The mushrooms were conveyed from Tank 2 on a mesh conveyor belt and rinsed with a potable water spray at a rate of 20 oz/min/nozzle using a five nozzle spray bar corresponding to 0.625 ounces of water per pound of mushrooms. From this conveyor, the mushrooms were next conveyed into Tank 3 containing the anti-microbial agent and acid activator for a residence time of 55 seconds. Mushrooms exited Tank 3 onto a mesh conveyor belt and were rinsed with potable water at a spray rate of 20 oz/min using with a four nozzle spray bar corresponding to 0.5 ounces of water per pound of mushrooms.

The treated and rinsed mushrooms were collected into plastic baskets with 10 pounds per basket. The baskets were stacked onto a pallet in a pattern allowing good air circulation. The pallet was moved to a forced ambient air drying system for 20 minutes and then moved to a cold storage room at 34° F. for 16 hours. Cooled mushrooms were then packed into one-pound plastic tills and overwrapped with clear PVC-based stretch film (PW-MF film from Pliant), with four (4) ⅛-inch diameter perforations in the top of the package. Unwashed mushrooms were packaged in the same way as a control.

Total aerobic bacterial plate counts (TAPC) were measured directly after washing and nine (9) days later near the end of normal shelf life. Initial TAPC of the unwashed mushrooms was 10⁵ colony forming units per gram (cfu/g) versus the washed mushrooms having an initial TAPC of 10³ cfu/g. After 9 days of cold storage at 40 degrees F, the TAPC of the unwashed mushrooms was 10⁶ cfu/g (colony forming units per gram) versus 10⁴ cfu/g for the washed mushrooms. Mushroom appearance for washed (sliced) mushrooms after 9 days of storage at approximately 40 degrees F. was significantly better than unwashed mushrooms.

### EXAMPLE 2

Five pounds of Food Grade Sodium Percarbonate (commercially available from Kingsfield, Inc.) was again added and mixed into 225 gallons of water in a tank (Tank 2). In this example, one-half gallon of sodium chlorite (obtained as Adox 750 commercially available from International Dioxcide, Inc.) and one pound of food grade tartaric acid (obtained from The Tartarics Chemical Corp of Modesto, Calif.) were added to 425 gallons of water (Tank 3).

As in Example 1, freshly harvested mushrooms were conveyed at a rate of 160 pounds per minute to a first tank (Tank 1) containing 225 gallons of potable water (no chemicals added). Residence time in Tank 1 was 30 seconds. From Tank 1, the mushrooms were conveyed directly into Tank 2, again with a residence time of 30 seconds. The mushrooms were conveyed from Tank 2 onto a mesh conveyor belt and rinsed with a potable water spray at a rate of 20 oz/min/nozzle using a five nozzle spray bar, corresponding to 0.625 ounces of water per pound of mushrooms. From this conveyor, mushrooms were conveyed into Tank 3 containing the anti-microbial agent and acid activator for a residence time of 55 seconds. Mushrooms exited Tank 3 onto a mesh conveyor belt and were rinsed with potable water at a spray rate of 20 oz/min using with a four nozzle spray bar, corresponding to 0.5 ounces of water per pound of mushrooms.

Again, as in Example 1, the washed/rinsed mushrooms were collected into plastic baskets with 10 pounds per basket. The baskets were stacked onto a pallet in a pattern allowing good air circulation. The pallet was moved to a forced ambient air drying system for 20 minutes and then moved to a cold storage room at 34 degrees F. for 16 hours. Cooled mushrooms were then packed into one-pound plastic tills and overwrapped with clear PVC-based stretch film (PW-MF film from Pliant), with four (4) ⅛-inch diameter perforations in the top of the package. Again, unwashed mushrooms were packaged in the same manner as a control.

For Example 2, the initial TAPC of unwashed mushrooms was 4×10⁴ cfu/g versus 1×10³ cfu/g for the washed mushrooms, a reduction in bacterial load of a factor of 40. The washed mushrooms exhibited a shelf life of 5 days longer salability versus the unwashed controls.

### EXAMPLE 3

Ten grams of the Food Grade Sodium Percarbonate was added and mixed into one gallon of water (stage 1 dip). Four and one-half grams of the sodium chlorite and one and one-tenth gram of ascorbic acid were added to a second one gallon container of water (stage 2 dip).

Fresh Fuji apples (from Washington State) were cored and sliced. Cores were discarded and slices were placed into the stage 1 dip for 30 seconds. The slices were then transferred to a colander for a quick water rinse. After draining for a several seconds, the slices were placed into the stage 2 dip for 55 seconds after which time they were removed and rinsed again with water. Four slices of each apple were placed into plastic bags having an oxygen transmission rate (OTR) of 1800 cc/m²·day·atm. These bags were labeled “treated.”

A second set of cored and sliced apples were dipped into 100 ppm chlorinated water for 30 seconds and allowed to drain in a colander as a control. Four slices of the control apples were similarly packed into bags of the same film. These bags were labeled “control.”

All bags of sliced apples were then sealed and stored at 40 degrees F. for 14 days. After 14 days, the “control” slices were turning brown and were soft, while the “treated” slices were of salable color and turgidity.

### EXAMPLE 4

One gallon of water was treated with 100 ppm chlorine using sodium hypochlorite (standard bleach with 10% active sodium hypochlorite) (stage 1 dip). Ten grams of the sodium percarbonate was added to a second gallon of water (stage 2 dip) and four and one-half grams of the sodium chlorite and one and one-tenth gram of ascorbic acid were added to a third one gallon container of water (stage 3 dip).

Fresh Texas Sweet onions were peeled and diced. These onions were first subjected to the stage 1 dip for 30 seconds. They were then transferred to a colander for a quick water rinse and allowed to drain for a few seconds before placing into the stage 2 dip for 30 seconds, after which they were placed into the colander for second quick water rinse. Finally, these same onions were transferred into the stage 3 dip for an additional 55 seconds. The diced onions were then removed from the third stage dip and rinsed again with potable water. Seventy-five grams of onions were placed into plastic bags with an OTR of 4500 cc/m²·day·atm. The bags were then sealed and held at 40 degrees F. for 14 days. These bags were labeled “treated.”

Similarly, diced onions were subjected to stage 1 dip for 30 seconds. These onions were placed into a colander and rinse quickly with potable water. After they were allowed to drain, seventy-five grams were placed into plastic bags with an OTR of 4500 cc/m²·day·atm. The bags were then sealed and held at 40 degrees F. for 14 days. These samples were labeled “control.”

After 14 days, the “treated” onions were more turgid than the “control” onions. These “treated” onions had slightly less onion odor than the “control” and appeared to be slightly more white, indicating the “control” onions were starting to become translucent—a sign of bacterial degradation. The onions were also tested for aerobic bacteria. Total plate counts (TPC) for the “control” samples were 15×10³ cfu/g, while the treated onions measured 4×10³ cfu/g.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A treatment system for preserving fresh produce comprising:
a first tank containing an aqueous solution of hydrogen peroxide having a pH greater than about 9.0;
a second tank containing an aqueous solution of an anti-microbial agent and an acid activator; and
a conveyor system to transfer fresh produce between the first and second tanks.

2. A treatment system as in claim 1, wherein the first tank further includes sodium carbonate.

3. A treatment system as in claim 2, wherein the first tank includes sodium percarbonate.

4. A treatment system as in claim 2, wherein the concentration of sodium carbonate is in the range of about 1600 to about 2000 milligrams sodium carbonate per liter of solution.

5. A treatment system as in claim 1, wherein the acid activator is selected from the group consisting of ascorbic acid, tartaric acid, fumaric acid, lactic acid, hydrochloric acid and combinations thereof.

6. A treatment system as in claim 1, wherein the anti-microbial agent is sodium chlorite.

7. A treatment system as in claim 1, wherein the anti-microbial agent is gaseous chlorine dioxide.

8. A treatment system as in claim 1, wherein the anti-microbial agent is sodium chlorite and wherein the acid activator is selected from the group consisting of ascorbic acid, tartaric acid and a combination thereof.

9. A treatment system as in claim 1, wherein the anti-microbial agent is sodium chlorite present in the solution in the range of about 50 ppm to about 150 ppm.

10. A treatment system as in claim 1, wherein the acid activator is selected from the group consisting of ascorbic acid, tartaric acid, and combinations thereof having a concentration in the range of about 200 to about 700 milligrams acid per liter of solution.

11. A treatment method for preserving fresh produce comprising:
providing fresh produce to be preserved;
washing the fresh produce with an aqueous solution of hydrogen peroxide having a pH greater than about 9.0; and
washing the fresh produce with an aqueous solution of an anti-microbial agent and an acid activator.

12. A treatment method as in claim 11, wherein the step of washing the fresh produce with an aqueous solution of hydrogen peroxide having a pH greater than about 9.0 is conducted prior to the step of washing the fresh produce with an aqueous solution of an anti-microbial agent and an acid activator.

13. A treatment method as in claim 11, wherein the step of washing the fresh produce with an aqueous solution of hydrogen peroxide having a pH greater than about 9.0 is conducted subsequent to the step of washing the fresh produce with an aqueous solution of an anti-microbial agent and an acid activator.

14. A treatment method as in claim 11, wherein the aqueous solution of hydrogen peroxide includes sodium carbonate.

15. A treatment method as in claim 11, wherein the aqueous solution of hydrogen peroxide has a pH in the range of about 9.0 to about 11.0.

16. A treatment method as in claim 11, wherein the step of washing with an aqueous solution of hydrogen peroxide includes washing the fresh produce with an aqueous solution having in the range of about 600 to about 1000 milligrams hydrogen peroxide per liter of solution and in the range of about 1600 to about 2000 milligrams sodium carbonate per liter of solution.

17. A treatment method as in claim 11, wherein the step of washing with an aqueous solution of hydrogen peroxide includes washing for a time in the range of about 20 seconds to about 5 minutes.

18. A treatment method as in claim 11, wherein the step of washing the fresh produce with an aqueous solution of an anti-microbial agent and an acid activator includes washing the fresh produce with an aqueous solution of sodium chlorite and an acid selected from the group consisting of ascorbic acid, tartaric acid, fumaric acid, lactic acid, hydrochloric acid and combinations thereof.

19. A treatment method as in claim 11, wherein the step of washing the fresh produce with an aqueous solution of an anti-microbial agent and an acid activator includes washing the fresh produce with an aqueous solution having in the range of about 50 ppm to about 150 ppm of sodium chlorite and in the range of about 200 to about 700 milligrams acid per liter of solution.

20. A treatment method as in claim 11, wherein the step of washing the fresh produce with an aqueous solution of an anti-microbial agent and an acid activator includes washing for a time in the range of about 20 seconds to about 5 minutes.

21. A treatment method as in claim 11, wherein the steps of washing include washing the fresh produce in an aqueous solution of hydrogen peroxide and sodium carbonate having a pH in the range of about 9.0 to about 11.0 and subsequently washing the fresh produce in an aqueous solution of sodium chlorite and an acid selected from the group consisting of ascorbic acid, tartaric acid, fumaric acid, lactic acid, hydrochloric acid and combinations thereof.

22. A treatment method as in claim 21,
wherein the first washing includes washing the fresh produce in an aqueous solution having in the range of about 600 to about 1000 milligrams hydrogen peroxide per liter of solution and in the range of about 1600 to about 2000 milligrams sodium carbonate per liter of solution for a time in the range of about 20 seconds to about 5 minutes, and
wherein the subsequent washing includes washing the fresh produce in an aqueous solution having in the range of about 50 ppm to about 150 ppm of sodium chlorite and in the range of about 200 to about 700 milligrams acid per liter of solution for a time in the range of about 20 seconds to about 5 minutes.

23. A treatment method for preserving fresh mushrooms to prevent bacterial breakdown and discoloration comprising:
providing fresh mushrooms;
washing the fresh mushrooms in an aqueous solution of sodium carbonate and hydrogen peroxide having a pH in the range of about 9.0 to about 11.0 for a period in the range of about 20 seconds to about 5 minutes; thereafter
washing the fresh mushrooms in an aqueous solution of sodium chlorite and an acid activator selected from the group of ascorbic acid, tartaric acid, and combinations thereof for a period in the range of about 20 seconds to about 5 minutes, wherein the aqueous solution of sodium carbonate and hydrogen peroxide has a concentration in the range of about 600 to about 900 milligrams hydrogen peroxide per liter of solution and in the range of about 1600 to about 2000 milligrams sodium carbonate per liter of solution and wherein the aqueous solution of sodium chlorite and the acid activator has a concentration in the range of about 50 ppm to about 150 ppm of sodium chlorite and in the range of about 200 to about 700 milligrams acid per liter of solution; and thereafter
rinsing the fresh mushrooms with potable water.

24. A treatment method for preserving fresh fruits and vegetables to prevent bacterial breakdown and discoloration comprising:
providing a fresh skinned fruit or vegetable;
washing the fresh skinned fruit or vegetable in an aqueous solution of sodium chlorite and an acid activator selected from the group of ascorbic acid, tartaric acid, and combinations thereof for a period in the range of about 20 seconds to about 5 minutes; thereafter,
washing the fresh skinned fruit or vegetable in an aqueous solution of sodium carbonate and hydrogen peroxide having a pH in the range of about 9.0 to about 11.0 for a period in the range of about 20 seconds to about 5 minutes, wherein the aqueous solution of sodium carbonate and hydrogen peroxide has a concentration in the range of about 600 to about 900 milligrams hydrogen peroxide per liter of solution and in the range of about 1600 to about 2000 milligrams sodium carbonate per liter of solution and wherein the aqueous solution of sodium chlorite and the acid activator has a concentration in the range of about 50 ppm to about 150 ppm of sodium chlorite and in the range of about 200 to about 700 milligrams acid per liter of solution; and thereafter
rinsing the fresh skinned fruit or vegetable with potable water.

25. A method as in claim 24, wherein the step of providing a fresh skinned fruit or vegetable comprises providing a fresh cut skinned fruit or vegetable.
